(19) United States
(12) Patent Application Publication
(10) Pub. No.: US 2018/0375161 A1
(43) Pub. Date: Dec. 27, 2018

(54) METHOD OF MANUFACTURING POSITIVE ELECTRODE FOR ALKALINE SECONDARY BATTERY AND METHOD OF MANUFACTURING ALKALINE SECONDARY BATTERY

(71) Applicant: TOYOTA JIDOSHA KABUSHIKI KAISHA, Toyota-shi (JP)

(72) Inventors: Motoyoshi OKUMURA, Nagoya-shi (JP); Masato HOZUMI, Mishima-shi (JP); Takuro KIKUCHI, Nagoya-shi (JP)

(73) Assignee: TOYOTA JIDOSHA KABUSHIKI KAISHA, Toyota-shi (JP)

(21) Appl. No.: 15/991,442

(22) Filed: May 29, 2018

(30) Foreign Application Priority Data
Jun. 27, 2017 (JP) 2017-125103

(51) Int. Cl. H01M 10/28; H01M 4/32; H01M 4/26; C01G 53/04; H01M 2/14; H01M 2/16; H01M 4/62

(52) U.S. Cl. CPC H01M 10/28; H01M 4/32; H01M 4/26; H01M 2004/027; H01M 2/145; H01M 2/1606; H01M 4/621; C01G 53/04

(57) ABSTRACT

(a1) A positive electrode active material containing at least one of nickel hydroxide and nickel oxyhydroxide is prepared. (a2) A positive electrode paste is prepared by mixing at least the positive electrode active material, a binder, and a solvent. (a3) A positive electrode for an alkaline secondary battery is manufactured by holding the positive electrode paste on a substrate and drying the positive electrode paste. By using an ion trapping agent in at least one of the positive electrode active material and the positive electrode paste, nitrogen compound ions are reduced.

This nonprovisional application is based on Japanese Patent Application No. 2017-125103 filed with the Japan Patent Office on Jun. 27, 2017, the entire contents of which are hereby incorporated by reference.

### BACKGROUND

### Field

The present disclosure relates to a method of manufacturing a positive electrode for an alkaline secondary battery and a method of manufacturing an alkaline secondary battery.

### Description of the Background Art

Japanese Patent Laying-Open No. 2017-054592 discloses concurrent use of a sulfonated separator and a hydrophilized separator in a nickel-metal hydride battery.

### SUMMARY

An “alkaline secondary battery” is a collective denotation of secondary batteries of which electrolyte is an alkaline aqueous solution. For example, a nickel-cadmium battery, a nickel-metal hydride battery, a nickel-zinc battery, and a nickel-iron battery fall under the alkaline secondary battery. These alkaline secondary batteries each include a nickel positive electrode.

The nickel positive electrode contains at least one of nickel hydroxide and nickel oxyhydroxide as a positive electrode active material. For example, a nickel nitrate aqueous solution or ammonia water is used for synthesis of the positive electrode active material. Therefore, the positive electrode active material may contain nitrogen compound ions such as nitric acid ions (NO₃⁻) or ammonium ions (NH₄⁺) as an impurity. When nitrogen compound ions are introduced into an alkaline secondary battery, due to a shuttle effect, self-discharge of the alkaline secondary battery can be promoted.

Japanese Patent Laying-Open No. 2017-054592 has proposed sulfonation of a separator. With trapping of nitrogen compound ions by sulfonate groups introduced into the separator, suppression of the shuttle effect is expected. Strength of the separator, however, can also be lowered by sulfonation. From a point of view of manufacturing cost, elimination or simplification of sulfonation is desired.

An object of the present disclosure is to suppress self-discharge of an alkaline secondary battery.

Technical features and functions and effects of the present disclosure will be described below. A functional mechanism of the present disclosure, however, includes presumption. The scope of claims for patent should not be limited by whether or not the functional mechanism successfully works.

[1] A method of manufacturing a positive electrode for an alkaline secondary battery in the present disclosure includes (a1) to (a3) below:

(a1) Preparing a positive electrode active material containing at least one of nickel hydroxide and nickel oxyhydroxide;

(a2) Preparing a positive electrode paste by mixing at least the positive electrode active material, a binder, and a solvent; and

(a3) Manufacturing a positive electrode for an alkaline secondary battery by holding the positive electrode paste on a substrate and drying the positive electrode paste.

Nitrogen compound ions are reduced by using an ion trapping agent in at least one of the positive electrode active material and the positive electrode paste.

In the present disclosure, in a process for manufacturing of a positive electrode for an alkaline secondary battery (which may hereinafter be abbreviated as a “positive electrode”), the ion trapping agent traps nitrogen compound ions to reduce the nitrogen compound ions. Namely, a positive electrode in which nitrogen compound ions are reduced is manufactured. Therefore, suppression of self-discharge of an alkaline secondary battery (which may hereinafter be abbreviated as a “battery”) is expected. As the nitrogen compound ions introduced into the battery are reduced, elimination or simplification of sulfonation of the separator is expected.

[2] The nitrogen compound ions may be at least one type selected from the group consisting of nitric acid ions, nitrous acid ions, and ammonium ions. As the nitrogen compound ions are reduced, suppression of self-discharge is expected.

[3] The positive electrode active material may be synthesized in an aqueous solution. The positive electrode active material in which the nitrogen compound ions are reduced may be synthesized by arranging the ion trapping agent in the aqueous solution. Suppression of self-discharge is thus expected.

[4] The method of manufacturing a positive electrode in the present disclosure may further include washing the positive electrode active material in a washing liquid. The nitrogen compound ions may be reduced in the positive electrode active material by arranging the ion trapping agent in the washing liquid. Suppression of self-discharge is thus expected.

[5] The positive electrode paste may be prepared by mixing at least the positive electrode active material, the binder, and the solvent in a container. The positive electrode paste in which the nitrogen compound ions are reduced may be prepared by arranging the ion trapping agent in the container. Suppression of self-discharge is thus expected.

[6] The nitrogen compound ions may be reduced in the positive electrode paste as a result of contact of the positive electrode paste with the ion trapping agent. Suppression of self-discharge is thus expected.

[7] A method of manufacturing an alkaline secondary battery in the present disclosure includes (A) to (D) below:

(A) Preparing the positive electrode for an alkaline secondary battery manufactured with the method of manufacturing a positive electrode for an alkaline secondary battery described in any one of [1] to [6] above;

(B) Preparing a negative electrode;

(C) Preparing a separator; and

(D) Manufacturing an alkaline secondary battery including at least the positive electrode for an alkaline secondary battery, the negative electrode, and the separator.

According to the manufacturing method, self-discharge of the alkaline secondary battery can be suppressed.

[8] The alkaline secondary battery may be a nickel-metal hydride battery. According to the manufacturing method, self-discharge of the alkaline secondary battery can be suppressed.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a flowchart showing overview of a method of manufacturing a positive electrode for an alkaline secondary battery in the present embodiment.

FIG. 2 is a flowchart showing overview of a method of manufacturing an alkaline secondary battery in the present embodiment.

### DESCRIPTION OF THE PREFERRED EMBODIMENTS

An embodiment of the present disclosure (which is herein also denoted as the “present embodiment”) will be described below. The description below, however, does not limit the scope of claims for patent.

A nickel-metal hydride battery is shown below by way of example of an alkaline secondary battery. The alkaline secondary battery in the present embodiment may be a nickel-metal hydride battery. The alkaline secondary battery in the present embodiment should not be limited to the nickel-metal hydride battery so long as it includes a nickel positive electrode. The battery in the present embodiment may be, for example, a nickel-cadmium battery, a nickel-zinc battery, or a nickel-iron battery.

For example, “at least one of A and B” herein encompasses all of “A alone,” “B alone,” and “both of A and B.”

<Method of Manufacturing Positive Electrode for Alkaline Secondary Battery>

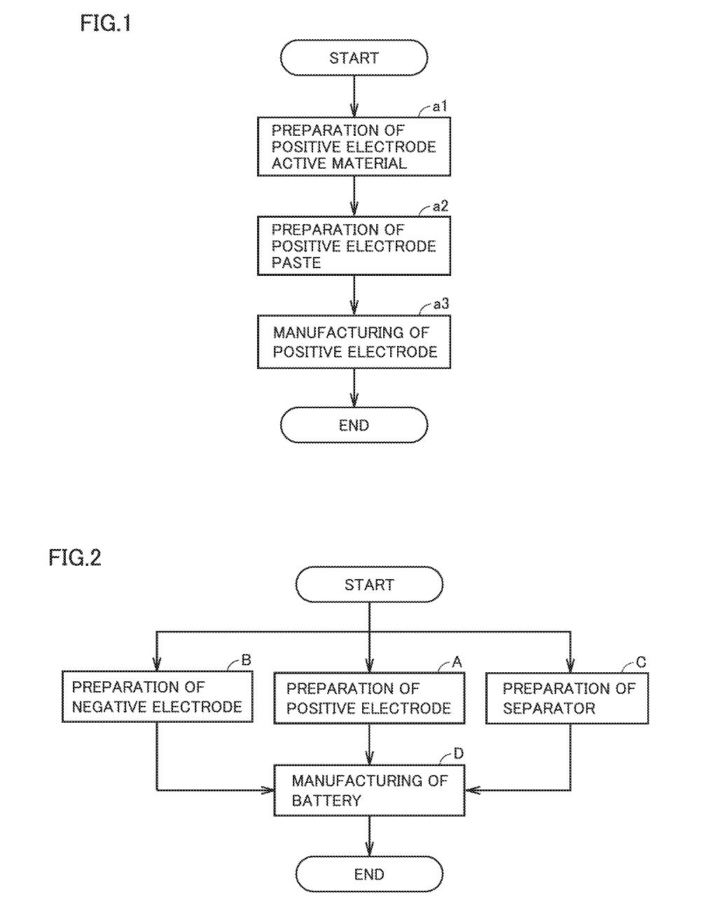

FIG. 1 is a flowchart showing overview of a method of manufacturing a positive electrode for an alkaline secondary battery in the present embodiment. The method of manufacturing a positive electrode in the present embodiment includes “(a1) preparation of positive electrode active material,” “(a2) preparation of positive electrode paste,” and “(a3) manufacturing of positive electrode.”

<<Ion Trapping Agent and Nitrogen Compound Ions>>

In the method of manufacturing a positive electrode in the present embodiment, nitrogen compound ions are reduced by using an ion trapping agent in at least one of a positive electrode active material and a positive electrode paste.

Nitrogen compound ions are polyatomic ions containing nitrogen atoms (N). Nitrogen compound ions may be, for example, at least one type selected from the group consisting of nitric acid ions (NO₃⁻), nitrous acid ions (NO₂⁻), and ammonium ions (NH₄⁺). These nitrogen compound ions are considered to be derived from a source material for a positive electrode active material. With introduction of these nitrogen compound ions into the battery, self-discharge of the battery can be promoted due to the shuttle effect.

An ion trapping agent can capture nitrogen compound ions. A form of the ion trapping agent should not particularly be limited. The ion trapping agent can be in various forms depending on each position of arrangement described later. The ion trapping agent can be in a form, for example, of powders, a sheet, or a web. The ion trapping agent may be used, for example, as being held on a substrate made of a resin.

The ion trapping agent may be an anion trapping agent, a cation trapping agent, or an amphoteric trapping agent. The amphoteric trapping agent can capture both of anions and cations. The ion trapping agent may be, for example, an ion exchanger. The ion exchanger captures nitrogen compound ions through ion exchange and releases substitute ions. Released ions can be, for example, potassium ions (K⁺), sodium ions (Na⁺), lithium ions (Li⁺), hydroxide ions (OH⁺), and hydrogen ions (H⁺).

The ion trapping agent, however, does not have to have ion exchange capacity so long as it can capture nitrogen compound ions. For example, the ion trapping agent may have only ion adsorptive capacity. Only one type of ion trapping agent may be used alone, or two or more types of ion trapping agents may be used as being combined. For example, an anion trapping agent and a cation trapping agent may be used as being combined.

The ion trapping agent may be a natural product or an artificial product. The ion trapping agent may be, for example, an inorganic compound. The ion trapping agent may be, for example, an inorganic ion exchanger. The inorganic ion exchanger can be, for example, zeolite powders or a clay mineral. The inorganic ion exchanger may be, for example, hydrotalcite [for example, Mg₆Al₂(OH)₁₆CO₃.mH₂O or Mg_{4.3}Al₂(OH)_{12.6}CO₃.mH₂O (m representing an integer from 1 to 10)], hydrocalumite, or pyroaurite.

A commercially available ion trapping agent may be employed. Examples of the commercially available ion trapping agents include “KYOWAAD® 200, an aluminum hydroxide based ion trapping agent manufactured by Kyowa Chemical Industry Co., Ltd.,” “KYOWAAD® 500, a hydrotalcite based ion trapping agent (an anion trapping agent) manufactured by Kyowa Chemical Industry Co., Ltd.,” “KYOWAAD® 600, a magnesium silicate based ion trapping agent (an amphoteric trapping agent) manufactured by Kyowa Chemical Industry Co., Ltd.,” “KYOWAAD® 700, an aluminum silicate based ion trapping agent (a cation trapping agent) manufactured by Kyowa Chemical Industry Co., Ltd.,” “KW-2000 (trade name), an aluminum oxide-magnesium oxide solid solution based ion trapping agent (an amphoteric trapping agent) manufactured by Kyowa Chemical Industry Co., Ltd.,” “DHT-4A®, a hydrotalcite based ion trapping agent (an anion trapping agent) manufactured by Kyowa Chemical Industry Co., Ltd.,” “IXE®-100, a zirconium phosphate based ion trapping agent (a cation trapping agent) manufactured by Toagosei Co., Ltd.,” “IXE®-300, an antimony oxide based ion trapping agent (a cation trapping agent) manufactured by Toagosei Co., Ltd.,” “IXE®-500, a bismuth oxide based ion trapping agent (an anion trapping agent) manufactured by Toagosei Co., Ltd.,” “IXE®-600, an antimony oxide-bismuth oxide based ion trapping agent (an amphoteric trapping agent) manufactured by Toagosei Co., Ltd.,” “IXEPLAS®-A1” manufactured by Toagosei Co., Ltd.,” “IXEPLAS®-A2” manufactured by Toagosei Co., Ltd.,” and “IXEPLAS®-B1” manufactured by Toagosei Co., Ltd.”

The ion trapping agent may contain at least one selected from the group consisting of hydrotalcite, aluminum hydroxide, magnesium silicate, aluminum silicate, aluminum oxide, magnesium oxide, zirconium phosphate, antimony oxide, and bismuth oxide.

The ion trapping agent may be, for example, an organic compound. The ion trapping agent may be, for example, an organic ion exchanger. The organic ion exchanger may be, for example, an ion exchange resin.

<<(a1) Preparation of Positive Electrode Active Material>>

The method of manufacturing a positive electrode in the present embodiment includes preparing a positive electrode active material containing at least one of nickel hydroxide and nickel oxyhydroxide. The positive electrode active material may be synthesized or purchased.

A discharged or charged positive electrode active material may be prepared. Nickel hydroxide (II) [Ni(OH)₂] represents a discharged positive electrode active material. Nickel oxyhydroxide [NiO(OH)] represents a charged positive electrode active material. The positive electrode active material contains at least one of nickel hydroxide and nickel oxyhydroxide.

So long as at least one of nickel hydroxide and nickel oxyhydroxide is contained, the positive electrode active material may contain another element or another compound. For example, nickel hydroxide may be coated with cobalt hydroxide [Co(OH)₂]. For example, magnesium (Mg), aluminum (Al), manganese (Mn), or zinc (Zn) may be added to nickel hydroxide.

The positive electrode active material may be synthesized in an aqueous solution. For example, a prescribed reaction container is prepared. A nickel nitrate [Ni(NO₃)₂] aqueous solution is introduced in the reaction container. A concentration of the nickel nitrate aqueous solution can be, for example, from 0.5 to 5 mol/l. Ammonia water is introduced in the reaction container. A concentration of ammonia water can be, for example, from 1 to 20 mass %. A sodium hydroxide (NaOH) aqueous solution is dropped into a solution mixture of the nickel nitrate aqueous solution and ammonia water. A concentration of the sodium hydroxide aqueous solution can be, for example, from 10 to 30 mass %. The solution mixture may be heated, for example, to 40 to 60° C. The solution mixture may be agitated. As a result of these operations, nickel hydroxide can be precipitated.

During synthesis of the positive electrode active material, an ion trapping agent may be arranged in the reaction container. With arrangement of the ion trapping agent in the aqueous solution, the positive electrode active material in which nitrogen compound ions are reduced may be synthesized. For example, an ion trapping agent in a form of a sheet may be arranged on an inner wall and a bottom surface of the reaction container. A powdery ion trapping agent may be introduced into the reaction container.

Precipitated nickel hydroxide is filtered out. Nickel hydroxide which has been filtered out may be washed. The method of manufacturing a positive electrode in the present embodiment may further include washing the positive electrode active material in a washing liquid. Water can typically be employed as the washing liquid.

During washing of the positive electrode active material, an ion trapping agent may be arranged in the washing liquid. With arrangement of the ion trapping agent in the washing liquid, nitrogen compound ions may be reduced in the positive electrode active material.

After filtering out or washing, nickel hydroxide (the positive electrode active material) is dried. After drying, nickel hydroxide may be crushed to have a prescribed particle size. After crushing, nickel hydroxide may have an average particle size, for example, from 1 to 20 μm. The “average particle size” herein refers to a particle size at which a cumulative volume from a finer side attains to 50% of the total volume in a volume-based particle size distribution measured with a laser diffraction/scattering method.

<<(a2) Preparation of Positive Electrode Paste>>

The method of manufacturing a positive electrode in the present embodiment includes preparing a positive electrode paste by mixing at least the positive electrode active material, a binder, and a solvent.

A general agitator can be used for a mixing operation. The positive electrode paste can be prepared, for example, by mixing at least the positive electrode active material, a binder, and a solvent in a prescribed agitation tank.

An amount of binder to be mixed may be, for example, from 0.1 to 10 parts by mass with respect to 100 parts by mass of the positive electrode active material. Examples of the binder may include carboxymethylcellulose (CMC), hydroxypropylcellulose (HPC), polyacrylic acid (PAA), polyvinyl alcohol (PVA), styrene-butadiene rubber (SBR), and polytetrafluoroethylene (PTFE). One type of binder may be used alone, or two or more types of binders may be used as being combined. The solvent can be selected as appropriate depending on a type of the binder. Water can typically be employed as the solvent.

So long as the positive electrode active material, the binder, and the solvent are mixed, another material may be added. Other materials include a conductive material and a dispersant. The conductive material can include, for example, cobalt oxide (CoO) and cobalt hydroxide.

An ion trapping agent may be used in preparation of the positive electrode paste. The positive electrode paste in which nitrogen compound ions are reduced may be prepared by arranging the ion trapping agent in the agitation tank. For example, the ion trapping agent may be arranged on an inner wall and a bottom surface of the agitation tank. The ion trapping agent may be arranged in a filter of a paste outlet portion in the agitation tank.

The ion trapping agent may be used after preparation of the positive electrode paste. Nitrogen compound ions in the positive electrode paste may be reduced as a result of contact of the positive electrode paste with the ion trapping agent. For example, the positive electrode paste may be passed through a cylinder filled with the ion trapping agent. The ion trapping agent may be arranged in a storage tank for the positive electrode paste. The ion trapping agent may be arranged in a primary storage tank or a circulation pipe in a coater which will be described later.

<<(a3) Manufacturing of Positive Electrode>>

The manufacturing method in the present embodiment includes manufacturing a positive electrode by holding the positive electrode paste on a substrate and drying the positive electrode paste.

The positive electrode paste may be held on the substrate by coating a surface of the substrate with the positive electrode paste. A general coater can be used for a coating operation. When the substrate is porous, the positive electrode paste may be held on the substrate by immersing the substrate in the positive electrode paste and impregnating the substrate with the positive electrode paste.

Examples of the substrate can include a porous metal, a perforated metal plate (a punched metal), and an expanded metal. Examples of the porous metal include nickel foam. The porous metal may have a porosity, for example, from 50 to 98%.

After the positive electrode paste is held on the substrate, the positive electrode paste is dried. The positive electrode is thus manufactured. After the positive electrode is dried, it may be compressed to a prescribed thickness, for example, by a roller. The positive electrode may be cut to a prescribed shape by a cutter. The positive electrode can be cut, for example, to a such a two-dimensional shape as a band shape or a rectangular shape.

The positive electrode in which nitrogen compound ions are reduced can be manufactured as above.

<Method of Manufacturing Alkaline Secondary Battery>

FIG. 2 is a flowchart showing overview of a method of manufacturing an alkaline secondary battery in the present embodiment. The method of manufacturing a battery in the present embodiment includes “(A) preparation of positive electrode,” “(B) preparation of negative electrode,” “(C) preparation of separator,” and “(D) manufacturing of battery.”

In the method of manufacturing a battery in the present embodiment, “(A) preparation of positive electrode,” “(B) preparation of negative electrode,” and “(C) preparation of separator” may be performed in any order.

<<(A) Preparation of Positive Electrode>>

The method of manufacturing a battery in the present embodiment includes preparing the positive electrode manufactured with the method of manufacturing a positive electrode in the present embodiment. Details of the method of manufacturing a positive electrode in the present embodiment are as described previously.

<<(B) Preparation of Negative Electrode>>

The method of manufacturing a battery in the present embodiment includes preparing a negative electrode. A method of manufacturing a negative electrode should not particularly be limited. The negative electrode can be manufactured with a conventionally known method. A method of manufacturing a negative electrode for a nickel-metal hydride battery is described herein by way of example.

A negative electrode active material is prepared. The negative electrode active material includes a hydrogen storage alloy. The hydrogen storage alloy may be, for example, an AB5 type alloy. Examples of the AB5 type alloy include LaNi₅ and MmNi₅ (“Mm” representing a misch metal). One type of hydrogen storage alloy may be used alone, or two or more types of hydrogen storage alloys may be used as being combined.

A negative electrode paste can be prepared by mixing the negative electrode active material, a binder, and a solvent. Materials the same as those for the positive electrode paste can be used for the binder and the solvent.

A substrate is prepared. For example, a perforated metal plate may be employed as the substrate. The perforated metal plate may be made, for example, of iron. The perforated metal plate may be plated, for example, with nickel. A surface of the substrate is coated with the negative electrode paste followed by drying. A negative electrode can thus be manufactured. The negative electrode can be rolled to a prescribed thickness. The negative electrode can be cut to a prescribed two-dimensional shape.

<<(C) Preparation of Separator>>

The method of manufacturing a battery in the present embodiment includes preparing a separator. The separator is an electrically insulating porous sheet. The separator should not particularly be limited. For example, nonwoven fabric of resin fibers may be employed as the separator. The resin fibers may be, for example, polypropylene (PP) fibers, polyethylene (PE) fibers, or polyamide (PA) fibers.

In the present embodiment, the separator may be sulfonated. Sulfonation can be performed, for example, by immersing the separator in sulfuric acid. In the present embodiment, however, nitrogen compound ions may have been reduced in the process for manufacturing a positive electrode as described previously. Therefore, sulfonation of the separator does not have to be performed or may be simplified. Simplification includes, for example, decrease in time period for treatment and lowering in concentration of a treatment liquid (sulfuric acid).

<<(D) Manufacturing of Battery>>

The method of manufacturing a battery in the present embodiment includes manufacturing a battery including at least the positive electrode, the negative electrode, and the separator.

An electrode group is made up. The electrode group can be made up by stacking the positive electrode in a form of a band, the separator in a form of a band, and the negative electrode in a form of a band in this order and spirally winding the stack. Alternatively, the electrode group can be made up by alternately stacking a plurality of rectangular positive electrodes and a plurality of rectangular negative electrodes with the separators being interposed therebetween.

A prescribed battery case (an exterior) is prepared. The battery case may be, for example, cylindrical or prismatic. The battery case may be made of a metal or a resin.

The electrode group is accommodated in the battery case. The positive electrode is electrically connected to a portion of the battery case which can serve as a positive electrode terminal. The negative electrode is electrically connected to a portion of the battery case which can serve as a negative electrode terminal.

An electrolyte is injected into the battery case. The electrolyte is an alkaline aqueous solution. The electrolyte can be prepared, for example, by dissolving a metal hydroxide into water. Examples of the metal hydroxide may include potassium hydroxide (KOH), sodium hydroxide (NaOH), and lithium hydroxide (LiOH). One type of metal hydroxide may be used alone, or two or more types of metal hydroxides may be used as being combined. A concentration of a metal hydroxide in the electrolyte may be, for example, from 1 to 15 mol/l. After injection of the electrolyte, the battery case is hermetically sealed.

A battery is manufactured as above. The battery in the present embodiment is less likely to self-discharge. This may be because nitrogen compound ions have been reduced in the process for manufacturing a positive electrode.

<Applications>

The battery in the present embodiment can be used, for example, as a power supply for driving of a hybrid vehicle (HV), a plug-in hybrid vehicle (PHV), and an electric vehicle (EV). Applications of the battery in the present embodiment should not be limited to a power supply for driving of a vehicle. The battery in the present embodiment can be applied to each and every application.

The present embodiment is illustrative and non-restrictive in every respect. The technical scope defined by the terms of the claims includes any modifications within the scope and meaning equivalent to the terms of the claims.

What is claimed is:

1. A method of manufacturing a positive electrode for an alkaline secondary battery comprising:
preparing a positive electrode active material containing at least one of nickel hydroxide and nickel oxyhydroxide;
preparing a positive electrode paste by mixing at least the positive electrode active material, a binder, and a solvent; and
manufacturing a positive electrode for an alkaline secondary battery by holding the positive electrode paste on a substrate and drying the positive electrode paste,
nitrogen compound ions being reduced by using an ion trapping agent in at least one of the positive electrode active material and the positive electrode paste.

2. The method of manufacturing a positive electrode for an alkaline secondary battery according to claim 1, wherein
the nitrogen compound ions are at least one type selected from the group consisting of nitric acid ions, nitrous acid ions, and ammonium ions.

3. The method of manufacturing a positive electrode for an alkaline secondary battery according to claim 1, wherein
the positive electrode active material is synthesized in an aqueous solution, and
the positive electrode active material in which the nitrogen compound ions are reduced is synthesized by arranging the ion trapping agent in the aqueous solution.

4. The method of manufacturing a positive electrode for an alkaline secondary battery according to claim 1, the method further comprising washing the positive electrode active material in a washing liquid, wherein
the nitrogen compound ions are reduced in the positive electrode active material by arranging the ion trapping agent in the washing liquid.

5. The method of manufacturing a positive electrode for an alkaline secondary battery according to claim 1, wherein
the positive electrode paste is prepared by mixing at least the positive electrode active material, the binder, and the solvent in a container, and
the positive electrode paste in which the nitrogen compound ions are reduced is prepared by arranging the ion trapping agent in the container.

6. The method of manufacturing a positive electrode for an alkaline secondary battery according to claim 1, wherein
the nitrogen compound ions are reduced in the positive electrode paste as a result of contact of the positive electrode paste with the ion trapping agent.

7. A method of manufacturing an alkaline secondary battery comprising:
preparing the positive electrode for an alkaline secondary battery manufactured with the method of manufacturing a positive electrode for an alkaline secondary battery according to claim 1;
preparing a negative electrode;
preparing a separator; and
manufacturing an alkaline secondary battery including at least the positive electrode for an alkaline secondary battery, the negative electrode, and the separator.

8. The method of manufacturing an alkaline secondary battery according to claim 7, wherein
the alkaline secondary battery is a nickel-metal hydride battery.
